(19) United States
(12) Patent Application Publication
(10) Pub. No.: US 2017/0057172 A1
(43) Pub. Date: Mar. 2, 2017

(54) Tool Path Generator with Embedded Process Control Commands for Additive Manufacturing

(71) Applicant: Sandia Corporation, Albuquerque, NM (US)

(72) Inventors: David M. Keicher, Albuquerque, NM (US); Adam Cook, Albuquerque, NM (US)

(21) Appl. No.: 15/244,966

(22) Filed: Aug. 23, 2016

Related U.S. Application Data
(60) Provisional application No. 62/209,167, filed on Aug. 24, 2015.

(51) Int. Cl. B29C 67/00; B33Y 10/00; B33Y 50/02; G05B 19/042; G05B 17/02

(52) U.S. Cl. CPC B29C 67/0088; G05B 19/0426; G05B 17/02; B33Y 50/02; B33Y 10/00

(57) ABSTRACT

A tool path generator with embedded process control commands enables feed-forward process control for additive manufacturing.

### CROSS-REFERENCE TO RELATED APPLICATION

This application claims the benefit of U.S. Provisional Application No. 62/209,167, filed Aug. 24, 2015, which is incorporated herein by reference.

### STATEMENT OF GOVERNMENT INTEREST

This invention was made with Government support under contract no. DE-AC04-94AL85000 awarded by the U.S. Department of Energy to Sandia Corporation. The Government has certain rights in the invention.

### FIELD OF THE INVENTION

The present invention relates to additive manufacturing and, in particular, to a tool path generator with embedded process control commands for additive manufacturing.

### BACKGROUND OF THE INVENTION

Additive Manufacturing (AM) technologies provide a platform on which new industrial revolution can be founded. However, the AM platform alone is not sufficient to truly revolutionize how manufacturing is performed. This revolution will require the combination of several technology platforms, including AM, to change how manufacturing is performed. Many of the technology components needed to revolutionize manufacturing now exist, but must be combined to significantly change the current approach to manufacturing. Predictive Process Modeling (PPM) capabilities provide a basis to enable virtual process simulation. Solid Modeling (SM) capabilities provide a means to capture and communicate design concepts. AM technologies provide a method to produce objects directly in a unique fashion. Separately, each of these technology platforms provides exceptional benefit to users in their field. However, the true potential of the new industrial revolution will only be realized when virtual process simulation can be used to optimize a process before manufacturing occurs and that process information can then translated into useable information that can directly drive the manufacturing process.

PPM has advanced to the point where it is now possible to simulate complex processes, such as laser powder deposition, with a reasonable accuracy. Using a constant laser input power, it can be predicted how the size of the melt pool will vary with each subsequent layer as the temperature within the part transitions from room temperature to the final equilibrium temperature maintained throughout the part build. Further, how the laser power needs to be varied in order to maintain a constant melt pool size given non-equilibrium conditions can be predicted. For example, experimental work shows that using constant laser power results in a smaller melt pool when the substrate is at room temperature and that the melt pool grows in size until equilibrium temperature conditions are achieved, as predicted. Similarly, this experimental work also shows how the laser power will vary if a constant melt pool size is maintained using closed-loop process control. Similar advancements are evident in the current state-of-the-art of AM technologies. Components can now be directly printed with good accuracy and mechanical properties in a variety of materials. However, efforts underway to evaluate the outcomes from these AM process are largely based on a traditional manufacturing model: build—test—optimize. This approach to developing manufacturing processes is labor intensive, costly and slow.

The present invention uses virtual process simulation to directly drive a manufacturing process through the combination of PPM, SM and AM.

### SUMMARY OF THE INVENTION

The present invention is directed to a method for additive manufacturing, comprising modeling a part geometry to identify equipotential regions; inserting virtual surfaces into the part geometry to differentiate between equipotential regions having constant process control input; creating a toolpath with embedded process control commands for the part geometry; and depositing a layer of material on a surface according to the embedded process control commands for the toolpath.

### BRIEF DESCRIPTION OF THE DRAWINGS

The detailed description will refer to the following drawings, wherein like elements are referred to by like numbers.

FIG. 1 is a diagram showing model-based feed-forward process control.

FIG. 2 is a schematic illustration showing typical vector-based toolpaths used for most current AM processes.

FIG. 3 is a schematic illustration showing an example of equipotential surface map for constant process input parameters.

FIG. 4 is a schematic illustration showing typical vector-based toolpaths overlaid onto slice layer with equipotential input surface contour map.

FIG. 5 is a schematic illustration showing modified vector-based toolpath generation based on virtual surface intersection method. Note that each vector corresponds to different input process conditions.

FIG. 6 is a diagram showing how model-based feed-forward process control can be used to impact final product development using AM technology.

### DETAILED DESCRIPTION OF THE INVENTION

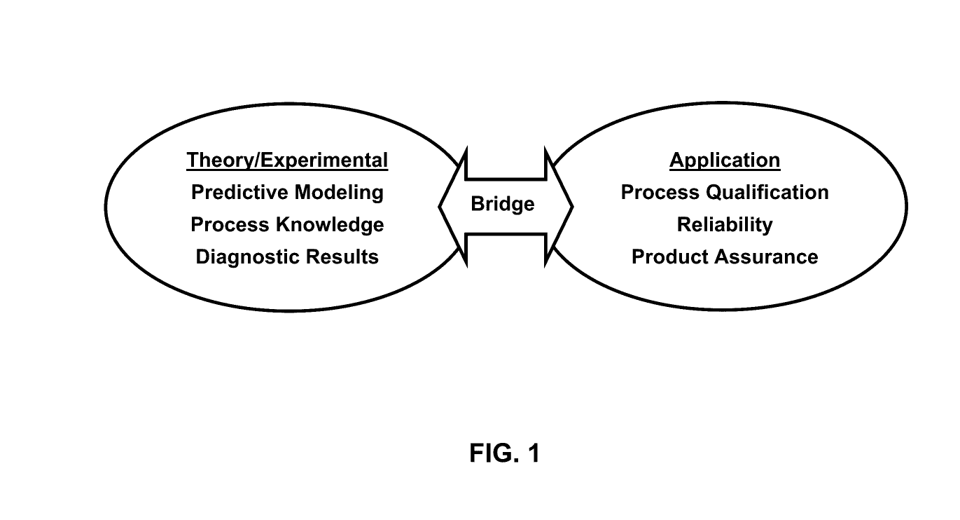

The current maturity levels of PPM, SM and AM technology platforms support a shift away from the traditional manufacturing approach to a method based on predictive capabilities. If a process can be largely optimized in a virtual environment as opposed to a physical environment, then the process development can be accelerated. Therefore, the present invention is directed to a model-based feed-forward process that can: simulate—optimize—build, where the build also provides the validation step for the process. To affect this change in manufacturing, a strong linkage needs to be created to bridge the gap between predictive/experimental capabilities and the manufacturing process to allow end users to benefit, as shown in FIG. 1. Success in this area will accelerate development of these new manufacturing capabilities.

Similar to AM technologies, other technologies which will impact this revolution have benefitted significantly from advancements in computing capabilities. Modeling capabilities have advanced to the point where it is now possible to simulate complex processes such as those used for AM with reasonable accuracy. Similarly, the ability to automate the design process will enable advancing the future of industrial processes.

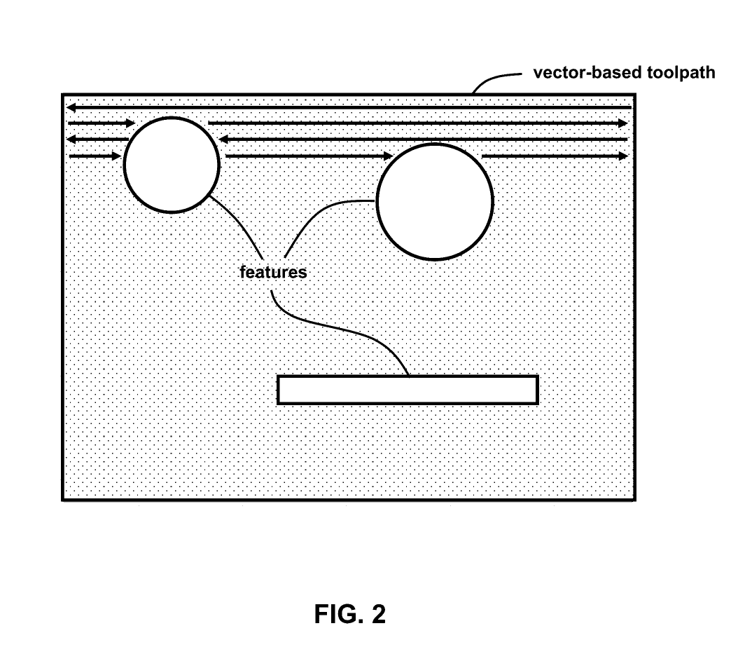

In current AM, a component is fabricated one layer at a time using a series of toolpath commands derived from the solid model rendering of the object to be fabricated. Software is used to first digitally slice the object into a series of layers with a predefined layer thickness that can be used to construct the object. Each layer is then further decomposed into a series of vectors that are used to define the outer/inner contours of the layer and a series of vectors that are used to define the fill region of the layer solid area. This approach is used almost exclusively for all layer-wise fabrication processes. The vectors are then translated into a series of toolpath commands that are used to direct the AM process in fabricating the component one layer at a time, as shown in FIG. 2. This approach is proven and works very well. However, the toolpath commands contain positional information only. Using predictive capabilities, there is an opportunity to associate process control commands with the toolpath to enable feed-forward process control.

As AM technologies are transitioned into the production of performance critical components, there is an increased need to incorporate capabilities into the AM systems and to ensure that more rigorous quality assurance demands are achieved. Integration of sensors to provide closed-loop process control has been demonstrated to provide some benefit to this end; however, this approach has limitations as the process scan speeds are increased. For many powder bed applications, the sense/control frequency needs to be greater than 10 kHz to be able to sense and respond to changes within a single laser spot size. This places a very high demand on computing resources and can contribute to out-of-control conditions if bandwidth is limited. Feed-forward control would provide a benefit to end users and product qualification.

Models have advanced to the point where they can be used to simulate processes with reasonably good accuracy so it is possible to predict which process inputs are needed in order to achieve the desired outcome on a voxel-by-voxel basis. The results of these analyses can provide very good information for feed-forward control but would yield a data set which is unwieldy in any practical implementation. A transitional approach needs to be developed to make use of the computational process data derived from these models that can be applied to implement feed-forward process control in a useful fashion.

It has been observed with directed energy AM processes that the process is generally stable requiring very little adjustment in bulk material areas where the heat flow conditions are constant. These bulk regions represent the idealized physics problems. However, as the heat source approaches a discontinuous feature, such as the edge of a structure, the process input must be varied to maintain constant response in the deposition. To provide a bridge between advanced modeling capabilities and the practical application of AM in an environment requiring rigorous qualification, a tool must be developed that can be provided to technology end users. Based on observations, a correlation can be developed to translate model data to component geometry in a fashion that allows current toolpath generation tools to be leveraged to create AM toolpaths with embedded process control commands.

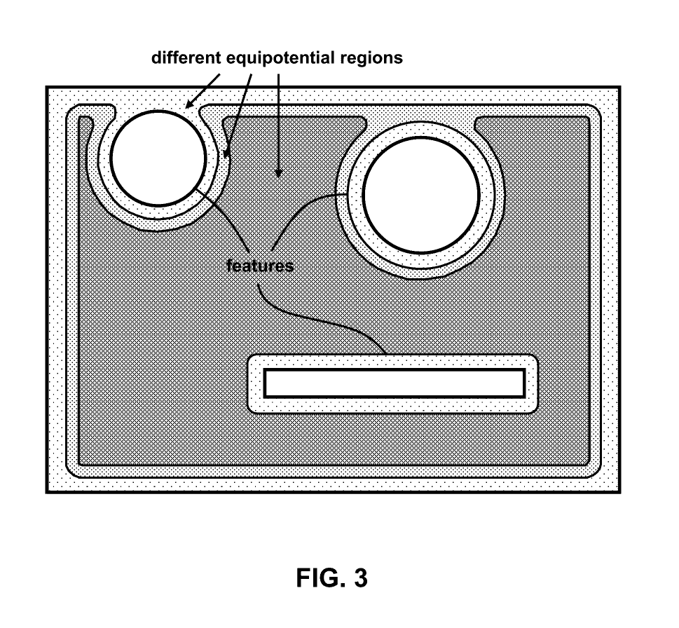

A method to accomplish this objective is described below. As previously discussed, to maintain constant properties in a direct energy beam AM process, changes in process control parameters are often required when the deposition process approaches a feature that modifies the flow of thermal energy in a part. These features can include building upon a thermal sink, such as the starting substrate or holes, edges and overhang features. FIG. 3 shows a graphical representation of what has been observed in direct energy beam AM processes. In this figure, each of the different shaded regions represents an equipotential region where the process input parameters are constant to maintain the same material properties across the part. The parameters that affect the heat flow include such things as material properties (i.e. thermal conductivity), process conditions (i.e. laser input, layer thickness) and other variables associated with the AM equipment (i.e. acceleration, velocity).

Note that these equipotential regions are three-dimensional. Modeling can be used to identify these regions. Once these regions have been identified, virtual surfaces can be inserted into the part geometry to differentiate between regions of constant process input conditions. These virtual surfaces can then be used in conjunction with current tool path generation approaches to create tool paths with embedded process control commands. This enables feed-forward control for AM processes.

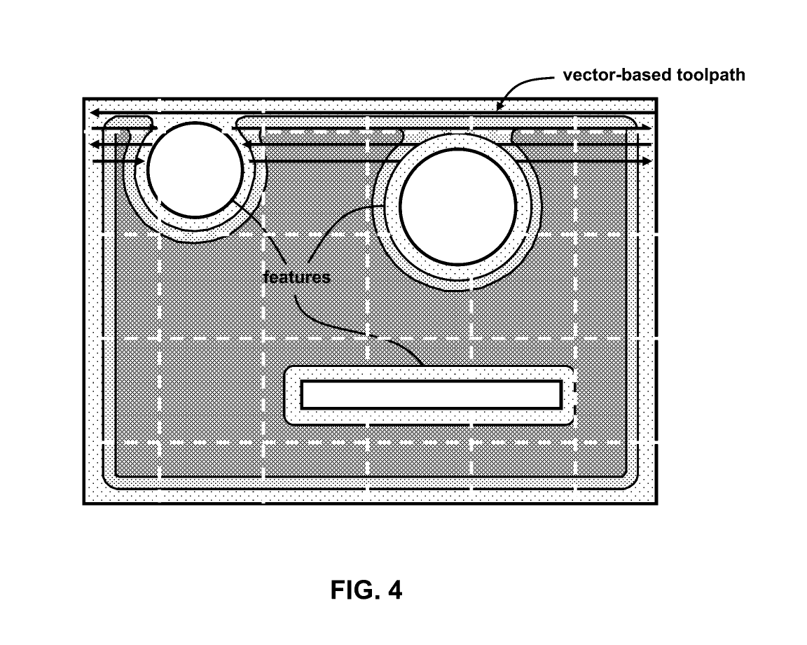

As previously mentioned, the current approach used to create toolpaths for most AM processes includes electronically slicing an object file into layers which are then used to generate a series of vectors that drive the deposition process. When an object containing the virtual surfaces is sliced electronically into layers, the slice layer looks similar to a contour map where different bands represent equipotential surfaces with similar process input requirements. The process input requirements will vary across the different equipotential surfaces. An example of the vector toolpaths overlaid onto the slice layer showing the equipotential surfaces is shown in FIG. 4. If one considers the interfaces between the equipotential surfaces to represent the virtual surfaces previously described, current toolpath generation routines can be modified to incorporate process control commands into the toolpath.

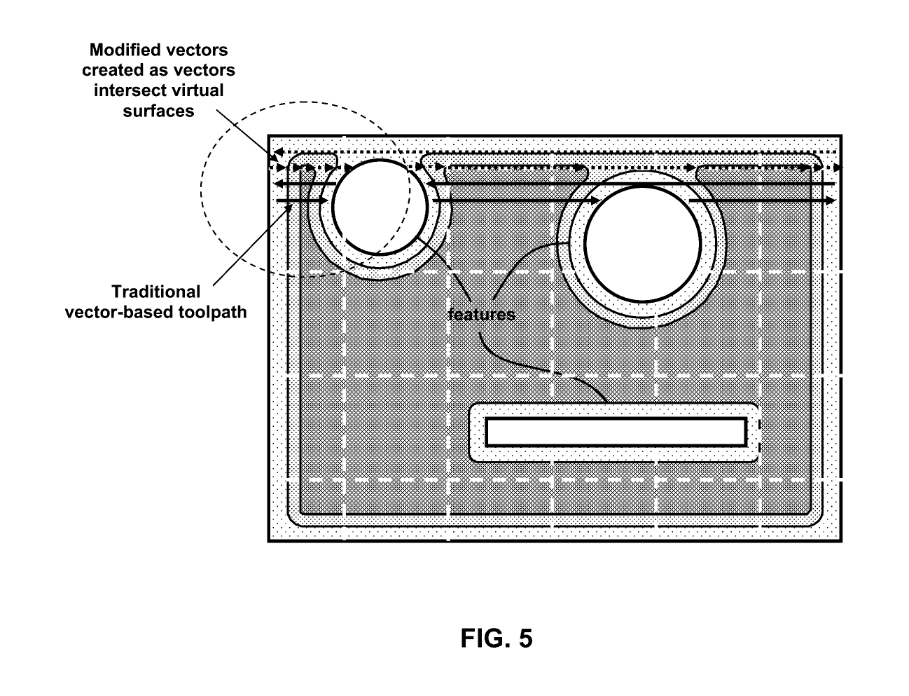

FIG. 5 shows an example of the creation of embedded process control commands into typical toolpaths. In the normal tool path generation approach, the software recognizes internal and external surfaces and uses these features to then create the vectors needed to fabricate a part one layer at a time. Allowing the slicing routines to also identify the virtual surfaces as a separate entity type according to the present invention allows separate vectors to be created for each of the equipotential regions. Associating the various vectors with the process conditions needed to create the condition required for a specific equipotential region then enables the creation of toolpaths with embedded process control commands.

This method provides a strong bridge between theory/experiment and application. Providing such tools to end users will accelerate the development and acceptance of AM technologies. This method allows existing infrastructure (i.e. current AM tools) to remain viable while also providing a path forward to move beyond the current state of the art in AM and providing a means for more reliable and consistent product from the AM machines. Feed-forward control may not eliminate the need for closed-loop control in some situations; however, it will provide a tool that can reduce the requirements for closed-loop control. In many cases, the sensors and tools developed for closed-loop control can instead be used to collect data for quality assurance and in-situ error detection.

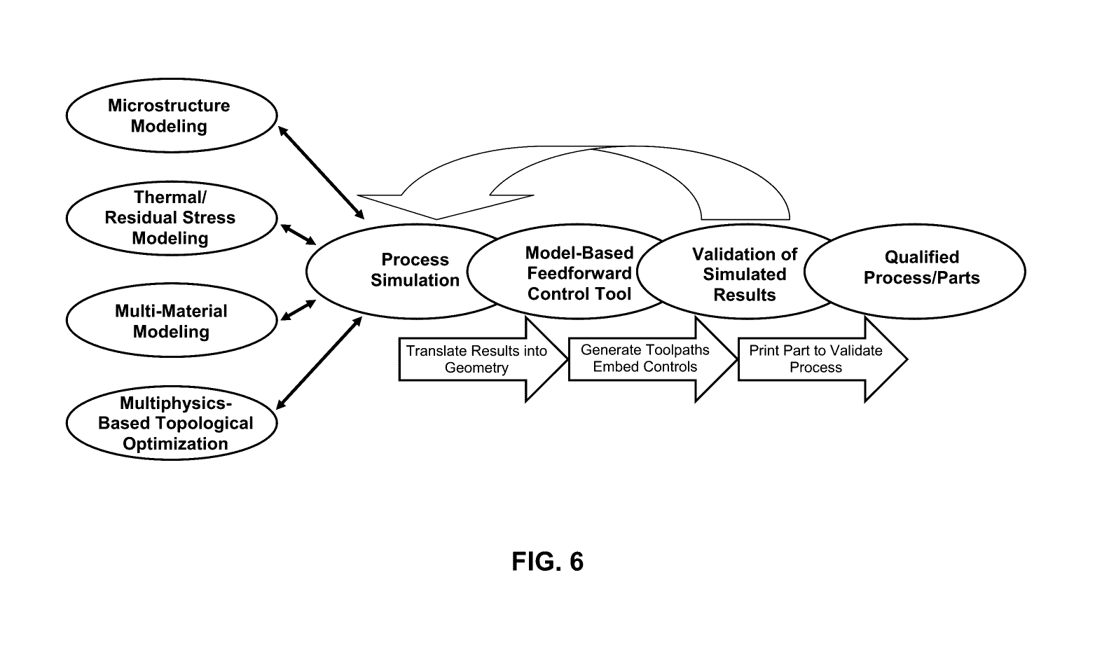

It should also be noted that many of the existing processes that are in use today were developed largely based on the old build-test-optimize model. This empirical-based development approach is costly, time consuming and hinders the rapid deployment of new materials and processes. Transitioning to the new simulate-optimize-build process provides an opportunity to accelerate development and qualification. Qualified material sets with existing property databases provide good materials on which this method can be developed and validated. Once validated, the predictive process capability can then be used to exploit the uniqueness offered through AM processes, as shown diagrammatically in FIG. 6. For example, using a single material, these validated predictive capabilities can be used to modify process conditions to locally enhance certain material properties as a component is being fabricated on an AM system. This application starts to move manufacturing into an area where little data exists. As new material sets are created for emerging AM technologies, these predictive capabilities will prove invaluable. Material property databases do not exist for multimaterial or gradient structures. In these situations, it no longer makes sense to rely on empirical-based approaches. In fact, it is detrimental and not necessary.

The present invention has been described as a tool path generator with embedded process control commands for additive manufacturing. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method for additive manufacturing, comprising:
modeling a part geometry to identify equipotential regions;
inserting virtual surfaces into the part geometry to differentiate between equipotential regions having constant process control input;
creating a toolpath with embedded process control commands for the part geometry; and
depositing a layer of material on a surface according to the embedded process control commands for the toolpath.
